(19) United States
(12) Patent Application Publication
(10) Pub. No.: US 2009/0031596 A1
(43) Pub. Date: Feb. 5, 2009

(54) METHOD OF CONSTRUCTING AN ORIGAMI-STYLE BOOKLET FROM A UNITARY BLANK OF SHEET MATERIAL

(76) Inventor: Robert M. PRPICH, Victoria (CA)

Correspondence Address: DAVIS & BUJOLD, P.L.L.C., 112 PLEASANT STREET, CONCORD, NH, 03301, US

(21) Appl. No.: 12/182,241

(22) Filed: Jul. 30, 2008

(30) Foreign Application Priority Data
Aug. 3, 2007 (CA) 2596299

(51) Int. Cl. G09F 1/00

(52) U.S. Cl. 40/124.06; 40/124.09

(57) ABSTRACT

A method of constructing an origami-style booklet from a unitary blank of sheet material. The blank of sheet material is divided into eight equal rectangles. The blank of sheet material is then cut widthwise along one of three notional boundary lines separating two of the rectangles, from one of opposed side edges to a notional centerline. The blank of sheet material is then lengthwise along the notional centerline starting one rectangle in from a top edge to one rectangle in from a bottom edge. The blank of sheet material is then folded lengthwise in accordion fashion about the three boundary lines and widthwise along the notional centerline until the rectangles are in face to face relation forming a booklet consisting of a front cover, a back cover and eight interior display surfaces.

### FIELD

The present invention relates lo a method of constructing an origami-style booklet from a unitary blank of sheet material.

### BACKGROUND

The website pocketmod.com discloses an origami-style of booklet consisting of a front cover, a back cover and six interior display surfaces formed from a single sheet of paper.

### SUMMARY

According there is provided a method of constructing an origami-style booklet from a unitary blank of sheet material. A first step involves providing a substantially rectangular unitary blank of sheet material having a top peripheral edge, a bottom peripheral edge and opposed side edges. A second step involves dividing the blank of sheet material into eight equal rectangles formed with a notional centerline extending between the top peripheral edge and the bottom peripheral edge and three notional boundary lines that extend between the opposed side edges. A third step involves cutting the blank of sheet material widthwise along one of the three notional boundary lines separating two of the rectangles. The widthwise cut extends from one of the opposed side edges to the notional centerline. A fourth step involves cutting the blank of sheet material lengthwise along the notional centerline starting one rectangle in from the peripheral top edge and one rectangle in from the peripheral bottom edge. A fifth step involves folding the blank of sheet material lengthwise in accordion fashion about the three boundary lines. A sixth step involves folding the blank of sheet material widthwise along the notional centerline. A seventh step involves placing the rectangles in face to face relation to complete formation of the booklet consisting of a front cover, a back cover and eight interior display surfaces.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a top elevation view of a unitary blank of sheet material.

FIG. 2 is a top elevation view of the unitary blank of sheet material from FIG. 1 after being cut.

FIGS. 3-7 are perspective views showing a method of folding the cut unitary blank of sheet material from FIG. 2.

FIG. 8 is a perspective view of an origami-style booklet formed by folding the cut unitary blank of sheet material from FIG. 2.

FIG. 9 is a perspective view the origami-style booklet from FIG. 8 opened for display.

FIG. 10 is a top elevation view of another unitary blank of sheet material.

FIG. 11 is top elevation view of the unitary blank of sheet material from FIG. 10 after being cut.

FIGS. 12-13 are perspective views showing a further method of folding the cut unitary blank of sheet material from FIG. 11.

FIG. 14 is a perspective view of an origami-style booklet formed by folding the cut unitary blank of sheet material from FIG. 11.

FIG. 15 is a perspective view of the origami-style booklet from FIG. 14 opened for display.

FIG. 16 is a magnified top elevation view of the unitary blank of sheet material from FIG. 11 showing rectangle 24.

FIG. 17 is a magnified top elevation view of the unitary blank of sheet material from FIG. 11 showing a method of cutting and folding rectangle 24.

FIG. 18 is a magnified top elevation view of the unitary blank of sheet material from FIG. 11 after cutting, folding, and securing rectangle 24 to rectangle 22 with a partial cut-away showing a credit card placed in a pocket cavity.

### DETAILED DESCRIPTION

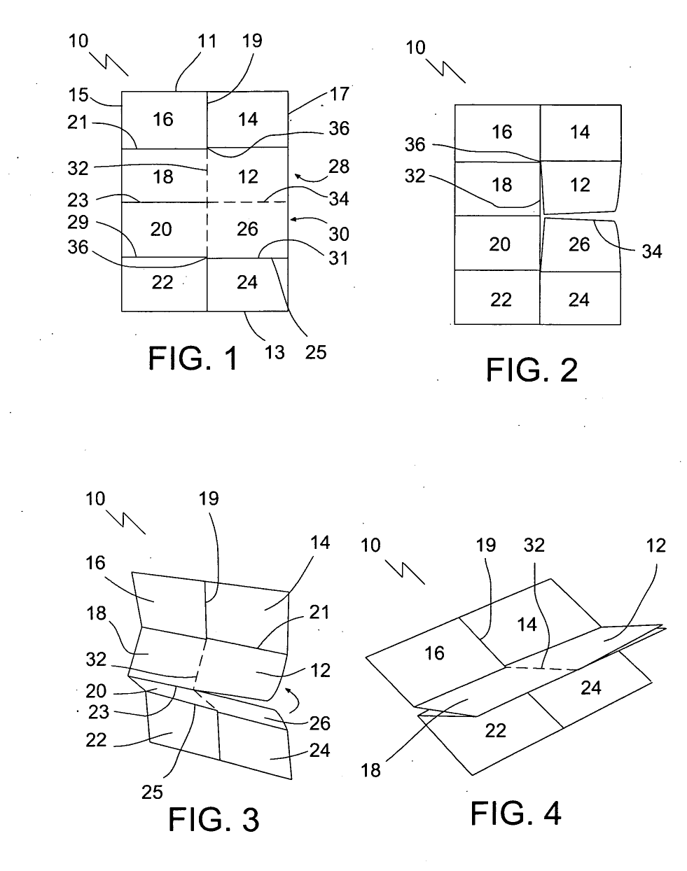

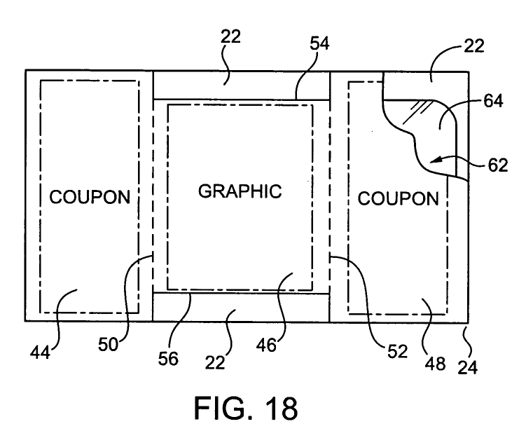

A preferred method of constructing an origami-style booklet from a unitary blank of sheet material will now be described with reference to FIGS. 1-9 and FIG. 16. A variation on the method will then be described with reference to FIGS. 10-15. An additional step of constructing a pocket within the origami-style booklet will be described with reference to FIGS. 17-18.

Referring to FIG. 1, a substantially rectangular unitary blank of sheet material 10 is shown having a top peripheral edge 11, a bottom peripheral edge 13, and left and right opposed side edges 15 and 17, respectively. Blank of sheet material 10 is shown in FIG. 1 as being divided into eight substantially equal rectangles 12, 14, 16, 18, 20, 22, 24, and 26. It should be noted that all of rectangles 12, 14, 16, 18, 20, 22, 24, and 26 may be equivalent in size or slightly different sizes. Front and back covers 28 and 30, respectively, are positioned on the opposite sides of rectangles 12 and 26, respectively as shown. Referring to FIG. 8, front and back faces 28 and 30, respectively, make up the front and back of origami-style booklet 38. Origami-style booklet 38 is created by folding and cutting blank of sheet material 10. Referring to FIG. 1, a notional centreline 19 extending between top peripheral edge 11 and bottom peripheral edge 13 separates rectangles 16, 18, 20, and 22 from respective rectangles 14, 12, 26, and 24. Notional centreline 19 is positioned a substantially equal distance from opposed side edges 15 and 17. Three notional boundary lines 21, 23, and 25 extend between opposed side edges 15 and 17. Notional boundary line 23 is positioned a substantially equal distance between top and bottom peripheral edges 11 and 13, respectively. Notional boundary line 21 is positioned between notional boundary line 23 and top peripheral edge 11, while notional boundary line 25 is positioned between notional boundary line 23 and bottom peripheral edge 13. Notional boundary lines 21 and 25 both may have a notch 36 running along notional centerline 19. Notch 36 is provided to position a left and right portion 29 and 31, respectively, of notional boundary lines 21 and 25 at different distances from top or bottom peripheral edges 11 and 13, respectively. By offsetting left and right portions 29 and 31, respectively, of notional boundary lines 21 and 25, this ensures that not all of rectangles 12, 14, 16, 18, 20, 22, 24, and 26 will have the same size, which may allow for easier opening of the pages during use, when using a sheet of material 10 with a greater thickness. It should be noted that similar notches may be positioned along any of notional lines 19, 21, 23 and 25, in order to compensate for folding thicker material.

Referring to FIG. 1, blank of sheet material 10 is cut along cut lines 32 and 34. Cut line 32 is positioned lengthwise along notional centerline 19 starting one rectangle in from peripheral top edge 11 and extending to one rectangle in from peripheral bottom edge 13. Cut line 34 is positioned widthwise along notional boundary line 23 extending from right opposed side edge 17 to notional centreline 19. Alternatively, cut line 34 may be on any one of three notional boundary lines 21, 23, and 25 separating two adjacent rectangles, the widthwise cut extending from one of opposed side edges 15 or 17 to notional centerline 19. Cut line 34 is shown as a symmetrical cut which divides blank of sheet material 10 into two equal portions. Referring to FIG. 2, both of cut lines 32 and 34 have been cut. Each of cut lines 32 and 34 may be cut at any point during the folding of blank of sheet material 10 shown in FIGS. 3-5, although it may be easier to cut line 32 while blank of sheet material is in the partially folded position shown in FIG. 4.

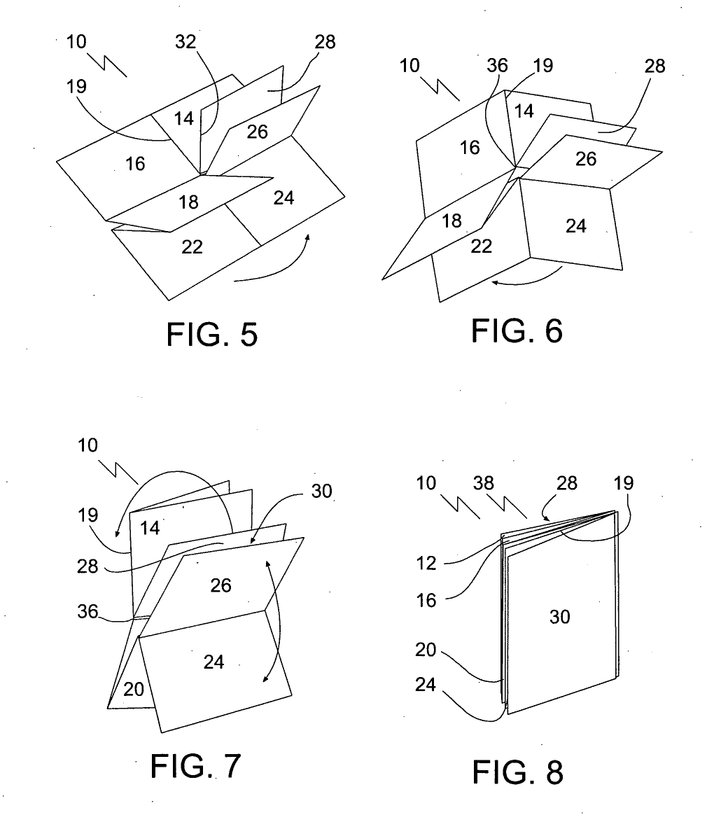

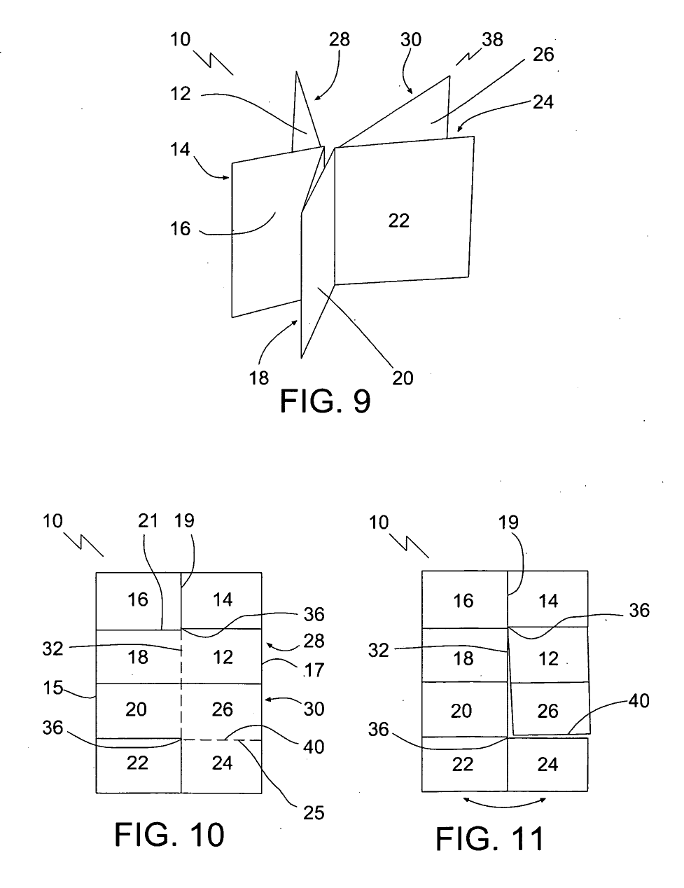

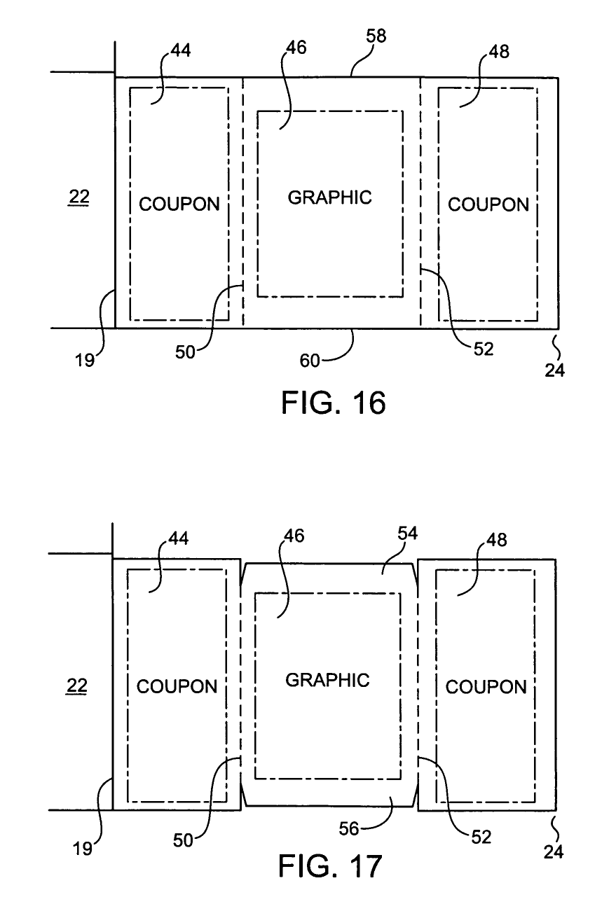

Referring to FIGS. 3-8, blank of sheet 10 is folded lengthwise in accordion fashion about each boundary separating the rectangles and widthwise along notional centerline 19, positioning the rectangles to form origami-style booklet 38 (shown in FIG. 8). Blank of sheet 10 may be cut along each of cut lines 32 and 34 at any stage shown between FIGS. 1-5. Referring to FIG. 3, blank of sheet 10 is folded as shown along notional boundary lines 21, 23, and 25. As shown in FIG. 3, blank of sheet 10 is folded inwardly along notional boundary 23, and outwardly along notional boundaries 21 and 25. Alternatively, the directions of folding may be reversed. The next step of folding involves increasing the degree of folding along notional boundaries 21, 23, and 25, and drawing rectangles 26 and 20 towards rectangles 12 and 15, respectively, along the direction indicated. Referring to FIG. 4, it is preferable to cut line 32 at this stage, if scissors (not shown) are being used to cut. Referring to FIG. 5, the remainder of notional centerline 19 is folded to give the orientation shown in FIG. 6. Referring to FIGS. 5-7, this is accomplished by drawing rectangles 16 and 22 towards rectangles 14 and 24, respectively, along the direction indicated. Referring to FIG. 7, the final step of folding involves pulling front and back covers 28 and 30, respectively, away from each other along the directions indicated, in order to form origami-style booklet 38 shown in FIG. 8. Referring to FIG. 9, once origami-style booklet 38 has been formed, rectangles 12, 14, 16, 18, 20, 22, 24, 26, form eight interior display surfaces which, in addition to front and back covers 28 and 30, respectively, may be used for display purposes. An example of a display purpose may be for the purpose of advertising. It should be understood that display information may be printed on any of the display pages, either before or after the cutting and folding of blank of sheet 10. One possible implementation is best shown in FIG. 16, where coupon panels 44, 46, and 48 are be formed on rectangle 24 by visual demarcation lines 50 and 52. The pages may display information of interest or may contain coupons, which can be cut out or are delineated by perforations to make easier to remove.

Variation of Method:

Alternatively, referring to FIG. 10, the step of cutting blank of sheet material 10 widthwise between one of opposed side edges 15 or 17 and notional centerline 19 may be done with an asymmetrical cut 40 along one of notional boundary lines 21, or 25. As shown in FIG. 10, asymmetrical cut 40 extends from right opposed side edge 17 to notional centreline 19 along notional boundary 25.

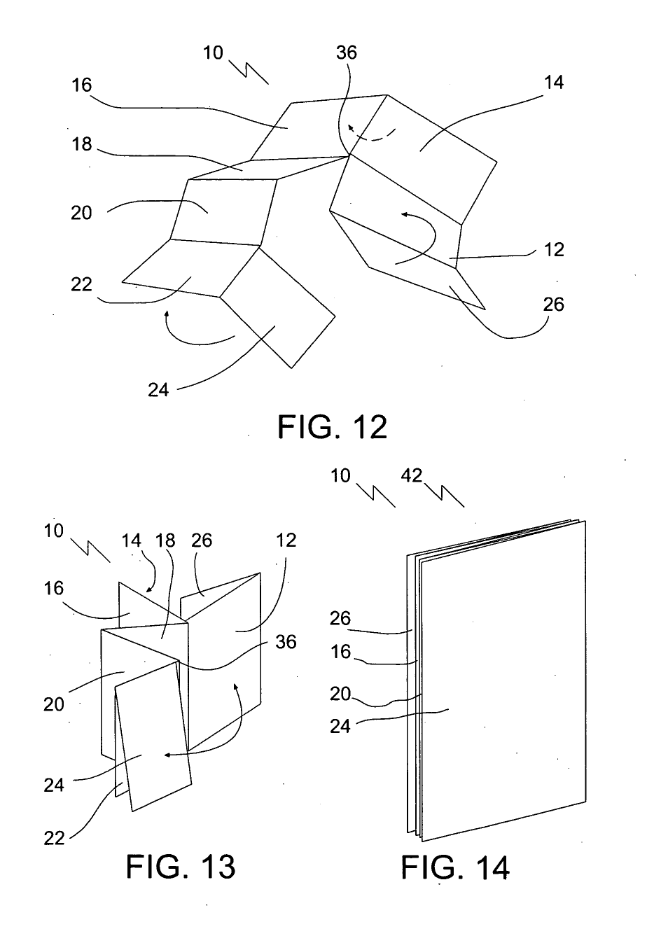

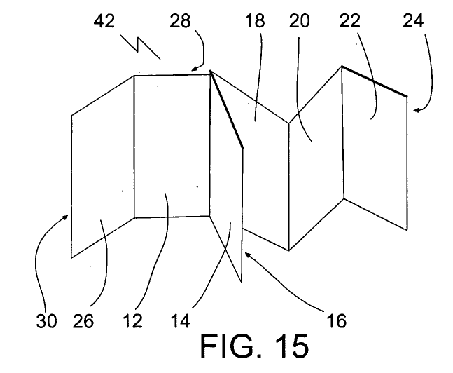

Referring to FIG. 11, both of cut lines 32 and 40 have been made. Blank of sheet material 10 is then folded inwardly along notional centreline 19, drawing rectangles 14, 12, 26, and 24 towards rectangles 16, 18, 20, and 22, respectively, along the direction indicated and giving the orientation shown in FIG. 12. In going from the orientation shown in FIG. 12 to that shown in FIG. 13, several steps occur. Rectangle 26 is drawn towards rectangle 12 along the direction indicated. Rectangle 14 is further drawn towards rectangle 16 along the direction indicated. Rectangle 22 is drawn towards rectangle 24 along the direction indicated. Rectangles 24 and 12 are rotated away from one another according to the direction indicated in order to complete origami-style booklet 42 shown in FIG. 14. Referring to FIG. 13, pairs of rectangles 14 and 16, 18 and 20, and 22 and 24 may be glued together in back to back relation. Referring to FIG. 15, once origami-style booklet 42 has been formed, rectangles 12, 14, 16, 18, 20, 22, 26, and 30 form eight interior display surfaces which, in addition to front cover 24 and back cover 28, respectively, may be used for display purposes and may now be opened and displayed in a fashion similar to that of origami-style booklet 38 described above. Differences to be noted are that rectangular panel 24 now becomes the front cover, instead of rectangular panel 28 (shown in more detail as the opposite face of rectangle 12 in FIG. 10) and rectangular panel 28 becomes the back cover instead of rectangular panel 30. There is also provided a three panel display consisting of panel 14 along with side by side fold out panels 12 and 26. This version provides an advantage when a greater display area is required.

Additional Step:

Additionally, referring to FIG. 17, cutting in starting from lengthwise edges 58 and 60 of rectangle 24 along visual demarcation lines 50 and 52 and ending before a point equidistant lengthwise edges 58 and 60 of rectangle 24 to form two adhesion flaps 54 and 56. Rectangle 24 is folded along notional centerline 19. Referring to FIG. 18, adhesion flaps 54 and 56 are folded under and adhesive is applied to adhesion flaps 54 and 56. Rectangle 24 is secured to rectangle 22 via adhesion flaps 54 and 56. Rectangles 22 and 24 form a pocket cavity 62 shown occupied by credit card 64 for illustrative purposes. It should be understood that pocket cavity shapes and dimensions ranging from those suitable for carrying hotel room keys, hotel room pass cards, gift cards or any other credit card sized object can be formed with rectangle 24 serving as a pocket front and rectangle 22 serving as a pocket back. The resulting pocket can hold suckers or other candies. It will be understood that a pocket cavity may be formed in this manner from any two sequentially placed rectangles.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A method of constructing an origami-style booklet from a unitary blank of sheet material, comprising:
providing a substantially rectangular unitary blank of sheet material having a top peripheral edge, a bottom peripheral edge and opposed side edges;
dividing the blank of sheet material into eight substantially equal rectangles formed with a notional centerline extending between the top peripheral edge and the bottom peripheral edge and three notional boundary lines that extend between the opposed side edges;
cutting the blank of sheet material widthwise along one of the three notional boundary lines separating two of the rectangles, the widthwise cut extending from one of the opposed side edges to the notional centerline;
cutting the blank of sheet material lengthwise along the notional centerline starting one rectangle in from the peripheral top edge and one rectangle in from the peripheral bottom edge;
folding the blank of sheet material lengthwise in accordion fashion about the three boundary lines;
folding the blank of sheet material widthwise along the notional centerline;
placing the rectangles in face to face relation to complete formation of the booklet consisting of a front cover, a back cover and eight interior display surfaces.

2. The method of claim 1, the step of cutting the blank of sheet material widthwise along one of the three notional boundary lines being a symmetrical cut along an inner one of the three notional boundary lines.

3. The method of claim 1, the step of cutting the blank of sheet material widthwise along one of the three notional boundary lines being an asymmetrical cut along an outer one of the three notional boundary lines.

4. The method of claim 1, including a step of gluing together those rectangles positioned in back to back relation.

5. The method of claim 1, including a step of visually demarcating at least one of the rectangles to form at least one coupon panel.

6. The method of claim 1, including a step of constructing a pocket,
wherein a pocket front consisting of a first of any two sequentially placed rectangles is secured to a pocket back consisting of a second of any two sequentially placed rectangles leaving a void defining a pocket cavity.

7. The method of claim 6, wherein the pocket front is secured to pocket back using adhesive.

8. The method of claim 6, wherein the pocket front and the pocket back are secured in a manner so as to produce various pocket cavity shapes and dimensions suitable for carrying objects ranging from candies to credit cards.

9. The method of claim 3, including a step of constructing a rectangular pocket, comprising:
dividing one of the two rectangles forming the front cover into three substantially equal sub-rectangles formed by two lengthwise edges, two widthwise edges and two visual demarcation lines extending between the lengthwise edges;
cutting in starting from the two lengthwise edges cutting along the two visual demarcation lines and ending before a point equidistant the two lengthwise edges to form two adhesion flaps;
folding the two adhesion flaps; and
securing with adhesive, the two adhesion flaps to the other rectangle forming the front cover.

10. The method of claim 9, wherein the two rectangles forming the front cover are secured in a manner so as to produce various pocket cavity shapes and dimensions suitable for carrying objects ranging from candies to credit cards.

11. An origami-style booklet, comprising:
a substantially rectangular unitary blank of sheet material having a top peripheral edge, a bottom peripheral edge and opposed side edges, the blank of sheet material being divided into eight substantially equal rectangles;
a widthwise cut being positioned along a boundary separating two of the rectangles, the widthwise cut extending from one of the opposed side edges to a notional centerline;
a lengthwise cut being positioned along the notional centerline starting one rectangle in from the peripheral top edge and one rectangle in from the peripheral bottom edge;
the blank of sheet material being folded lengthwise in accordion fashion about each boundary separating the rectangles and widthwise along the notional centerline with the rectangles being positioned to form the booklet consisting of a front cover, a back cover and eight interior display surfaces.

12. The origami-style booklet of claim 11, wherein the widthwise cut is a symmetrical cut which divides the blank of sheet material into two equal portions.

13. The origami-style booklet of claim 11, wherein the widthwise cut is an asymmetrical cut which divides the blank of sheet material into two unequal portions.

14. The origami-style booklet of claim 11, wherein those rectangles positioned in back to back relation are glued together.

15. The origami-style booklet of claim 11, wherein at least one of the rectangles is visually demarcated to form at least one coupon panel.

16. The origami-style booklet of claim 11, wherein a pocket front consisting of a first of any two sequentially placed rectangles is secured to a pocket back consisting of a second of any two sequentially placed rectangles leaving a void defining a pocket cavity.

17. The origami-style booklet of claim 16, wherein the pocket front is secured to pocket back using adhesive.

18. The origami-style booklet of claim 16, wherein the pocket cavity is suitable for carrying objects ranging from candies to credit cards.

19. The origami-style booklet of claim 13, including a rectangular pocket,
wherein one of the two rectangles forming the front cover is divided into three substantially equal sub-rectangles formed by two lengthwise edges, two widthwise edges and two visual demarcation lines extending between the lengthwise edges;
the two visual demarcation lines are cut starting from the two lengthwise edges and ending before a point equidistant the two lengthwise edges to form two adhesion flaps;
wherein the two adhesion flaps are folded; and
secured with adhesive to the other one of two rectangles forming the front cover.

20. The origami-style booklet of claim 19, wherein the pocket cavity is suitable for carrying objects ranging from candies to credit cards.
